(19) United States
(12) Patent Application Publication
(10) Pub. No.: US 2009/0016569 A1
(43) Pub. Date: Jan. 15, 2009

(54) Method of Controlling the Flow of Adjuvant for the Casting of a Molten Metal

(75) Inventors: Nicolas Mocellin, Villeurbanne (FR); Patrick Simonnin, Ecully (FR)

Correspondence Address: Ralph A. Dowell of DOWELL & DOWELL P.C., 2111 Eisenhower Ave, Suite 406, Alexandria, VA, 22314, US

(73) Assignee: STE D'etudes et de realisations Techniques S.E.R.T, Decines (FR)

(21) Appl. No.: 12/223,590

(22) PCT Filed: Feb. 2, 2007
(86) PCT No.: PCT/FR2007/000194

§ 371 Date: Aug. 4, 2008

(30) Foreign Application Priority Data
Feb. 3, 2006 (FR) 06 00992

(51) Int. Cl. G06K 9/00

(52) U.S. Cl. 382/100

(57) ABSTRACT

According to this method, the adjuvant is delivered from a supply means (12) placed above the casting bowl (4), a target zone (Z) for the theoretical passage of this adjuvant is chosen, said zone lying downstream of the supply means (12), and the actual passage of the adjuvant in the target zone (Z) is detected optically, by means of at least one camera (14). At least one image of the target zone (Z) is taken by means of the or each camera (14), this image being taken with an exposure time short enough to identify the density of particles of this adjuvant that are present in the or each image, and a warning signal is generated if the measured particle density is below a predetermined value.

The present invention relates to a method of checking the flow of an adjuvant for casting a molten metal.

In the foundry field, it is known to produce, by means of a mold pattern, a succession of molds or flaskless molds that are displaced axially in the direction of a casting machine that can pour molten metal. A pouring basin, intended to receive that molten metal, is connected via a supply channel to the cavity to be filled.

Depending on the desired characteristics of the final material, at the same time as the molten metal is poured into the pouring basin, it is sometimes necessary to pour in an adjuvant intended to endow the cast metal with particular metallurgical characteristics during solidification. As an example, if it is desired to limit the formation of carbides, it is known to use a ferro-silicon based adjuvant termed an inoculant. That method is termed “late inoculation”.

In this regard, a device is provided that can distribute the adjuvant above the pouring basin. It is, for example, an endless screw that can measure out the adjuvant and then convey it towards an inclined supply tube having its downstream end placed above the pouring basin and close to the stream of molten metal.

In a first solution, said adjuvant is distributed continuously so that it is poured not only into the pouring basin but also onto the surfaces of the flaskless molds as they are displaced. Apart from the cost associated to the high consumption of adjuvant, that solution also pollutes the sand constituting the flaskless molds as well as the mechanical elements of the installation as a whole.

It is also known to pour the adjuvant in a discontinuous manner. In this regard, when the pouring basin is stopped in vertical alignment with the casting machine, the action of the screw is initiated to cause the adjuvant to be poured. Next, casting proper is carried out. Once casting is complete, the supply of adjuvant is stopped.

During the process described above, there is a risk that the supply tube may become blocked, possibly due to molten metal being sprayed onto the downstream end of that tube. Thus, it is necessary to check that the adjuvant is added correctly to the pouring basin in order to endow the molten metal with the required properties.

To this end, French patent FR-A-2 820 063 describes a process for checking the flow of such an adjuvant in which initially, a target zone is selected on the theoretical path of the adjuvant, the zone being disposed downstream from the device supplying the adjuvant. Next, the actual passage of the adjuvant in said target zone is detected optically, in particular using a CCD type camera. Finally, in the event that camera does not detect adjuvant that ought theoretically to be present in the target zone, an alarm signal is generated to warn the operator.

That known solution is generally completely satisfactory. However, the invention aims to improve the precision of that prior art checking method, in particular for certain values of the flow rate of the casting adjuvant.

To this end, the invention provides a method of checking the flow of a casting adjuvant intended to be distributed when casting a molten metal into a pouring basin, wherein the adjuvant is distributed from a supply means, in particular tubular supply means, disposed above the pouring basin, a target zone is selected on the theoretical path of said adjuvant disposed downstream of the supply means, the actual passage of the adjuvant in the target zone is detected optically using at least one camera and, if appropriate, an alarm signal is generated;

the method being characterized in that at least one image of the target zone is produced using the or each camera, applying to said image an exposure that is sufficiently short to identify the density of the particles of said adjuvant present on the or each image, and the alarm signal is generated if the identified particle density is below a predetermined value.

Other characteristics of the invention are as follows:
the exposure for each image is in the range 0.1 milliseconds (ms) to 0.5 ms;
the exposure for each image is about 0.2 ms;
the adjuvant is distributed at a flow rate of less than 10 grams/second (g/s), preferably less than 9 g/s;
the or each camera is of the CMOS type;
several images are produced throughout casting of the molten metal into the pouring basin and the alarm signal is generated if, for at least one of said images, the identified particle density of the adjuvant is below said predetermined value;
two successive images are separated by an interval lasting in the range 40 ms to 80 ms;
the adjuvant is poured directly into a stream of said molten metal;
at least one first camera is used looking along a direction parallel to a principal axis of the flow of adjuvant particles as viewed from above, as well as at least one second camera looking along a direction at an angle that is offset relative to the direction of the first camera;
the direction of the first camera and the direction of the second camera are mutually offset by an angle in the range 10° to 30°, especially about 20°.

The invention is described with reference to the accompanying drawings given solely by way of non-limiting example and in which:

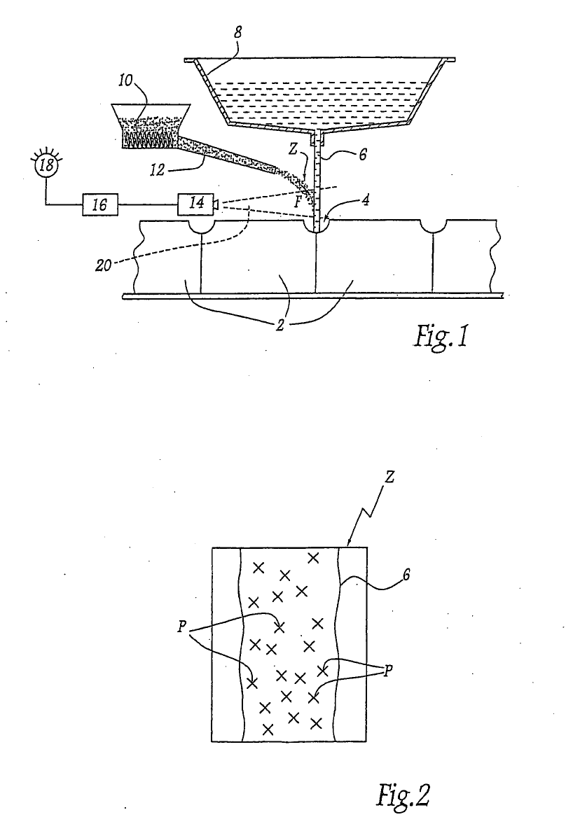

FIG. 1 is a side view illustrating a first implementation of the method of the invention;

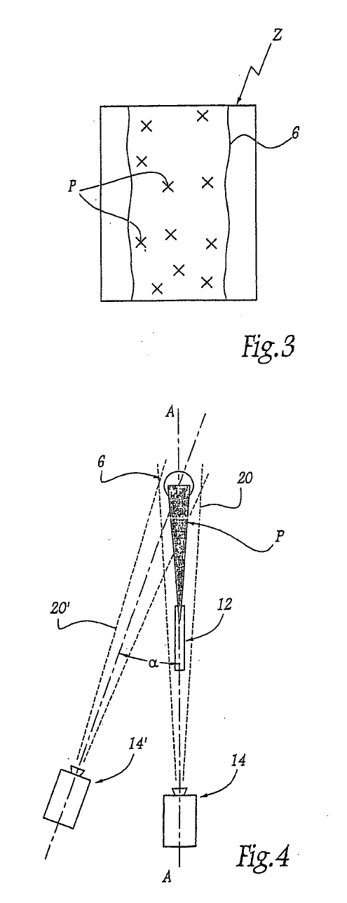

FIGS. 2 and 3 are front views illustrating two images obtained by carrying out the method of the invention; and

FIG. 4 is a top view illustrating a second implementation of the method of the invention.

FIG. 1 shows the general context in which the method of the invention is implemented. It shows a plurality of juxtaposed flaskless molds, each of which has reference numeral 2. Each pair of flaskless molds defines a pouring basin 4 in its common plane.

The pouring basin can receive a stream of molten metal 6 poured from a casting machine 8. The flow rate of the metal flowing from the machine 8 is controlled in known manner by a stopper rod, not shown, or by any other system. During the casting operation, it is sometimes necessary to add an adjuvant such as an inoculant to the molten metal 6.

To this end, means for distributing said adjuvant are provided, which means comprise measuring out and conveying means, for example an Archimedes screw 10, extended by a supply tube 12 extending obliquely to the horizontal. The theoretical path followed by the adjuvant between the downstream end of the tube 12 and the pouring basin 4 is represented by arrow F.

In accordance with the teaching of FR-A-2 820 063, a target zone is selected, denoted overall by reference letter Z, which zone extends from the downstream end of the supply tube 12 to the neighborhood of the region where the stream of metal 6 flows. This zone Z corresponds to the theoretical path followed by the adjuvant towards the pouring basin 4.

FIG. 1 also shows an optical device that allows the method of the invention to be implemented. First of all, this device comprises a camera 14, for example of the CMOS type (complementary metal oxide semiconductor). The camera 14 is connected to an image analysis system 16 associated with an alarm 18, for example of the visual type.

The camera 14 is located on the same side of the metal stream 6 as the distribution means 10, 12, substantially in vertical alignment thereto. The viewing direction 20 of the camera 14 is directed towards the target zone Z in the theoretical path of the adjuvant.

The casting method is implemented as follows.

Once the train of flaskless molds stops so that the pouring basin 4 is in vertical alignment with the casting machine 8, the screw 10 is actuated to initiate distribution of the adjuvant towards said pouring basin 4. Simultaneously, molten metal 6 starts to pour from the casting machine 8, it being understood that the first particles of adjuvant must reach the pouring basin 4 before it receives the stream of molten metal 6, thereby endowing the molten metal that enters the pouring basin with the required properties.

The supply tube 12 is located so that as soon as the molten metal 6 flows, the adjuvant is poured directly into the stream of said molten metal. This measure is advantageous since it allows the stream to entrain the adjuvant so that the adjuvant melts instantaneously. In contrast, if the adjuvant is distributed directly into the pouring basin, it floats for a certain time before being melted, which leads to the formation of plaques of agglomerated adjuvant that may remain at the top of the pouring basin until the end of casting.

In order to check that the adjuvant has entered the pouring basin 4 correctly, the camera 14 is capable of detecting the contrast caused by particles of adjuvant being interposed between said camera and the stream of molten metal 6, which constitutes a bright uniform background. Such detection, termed silhouette detection, is carried out in a manner that is known per se.

In accordance with the invention, a technique that is known per se, termed shutterization, is used on said camera 14 using an electronic shutter. Under these conditions, the exposure of each image that may be produced by the camera is substantially shorter than conventional exposures. Thus, if the normal exposure is of the order of 40 ms, the exposure in accordance with the invention has a value in the range 0.1 ms to 0.5 ms, i.e. 100 microseconds (μs) to 500 μs. An example that may be given as a typical value for the exposure of the invention is 200 μs.

FIGS. 2 and 3 show two images produced by the camera 14, using the procedure of the invention as explained above. These figures show the target zone Z and the stream 6 of molten metal that flows through this zone Z. Given the very short exposure, the position of the particles of adjuvant in three-dimensional space is stationary so that it is possible to distinguish the particles on the images of FIGS. 2 and 3.

On these figures, the particles of adjuvant, which are given reference letter P, are represented diagrammatically in the form of crosses. It is then possible to, in a simple and accurate manner, identify the density of said particles P in the target zone Z, namely the surface area of said zone Z in which the particles P are present; that surface area is in contrast relative to the stream 6 of molten metal.

Clearly, this particle density, which is thus identified using the camera 14 and the analysis system 16, is representative of the quantity of adjuvant that is actually present in target zone Z at a given instant.

In order to carry out a satisfactory check of the flow, a threshold value must be determined in advance for the particle density P, as defined above. In this regard, a standard casting is carried out in which the presence of the adjuvant in the stream of molten metal is verified visually. As explained above, it is then possible, during the standard casting, to identify the density of particles P present in the zone Z, thereby leading to said threshold value, and applying a certain amount of tolerance, where appropriate.

Next, once said threshold value has been determined, various images that are analogous to FIGS. 2 and 3 are produced during the whole of the casting phase, the duration of which is typically in the range 5 seconds (s) to 20 μs. These various images are taken at regular intervals; the value is typically in the range 40 ms to 80 ms. This therefore provides access to several hundred images, each one of which is representative of the presence of adjuvant in the target zone at a given instant.

In the event that the measured density of the particles P is less than the threshold value determined as above and over a significant number of said images, then the image analysis system 16 activates the alarm 18 to warn the operator. The image of FIG. 2 would not result in activation of the alarm since the density of the particles P present in the target zone Z is sufficiently high. In contrast, this density of particles P measured on the image of FIG. 3 is lower, and below the threshold value, and would thus trigger the alarm.

The invention can achieve the objectives mentioned above.

The Applicant has in fact established that for relatively low adjuvant flow rates, the solution described in FR-A-2 820 063 has a few limitations as regards precision.

Thus, using the CCD camera mentioned in that prior art, which has a typical exposure period for each image of 40 ms, the particles of adjuvant form black lines that are difficult to identify on the images produced using the camera. Under those conditions, for the slow flow rates mentioned above, in particular rates lower than about 10 g/s, the presence of such lines may lead to a false determination of the quantity of adjuvant actually present in the target zone.

In contrast, by means of the invention, the fact of reducing the exposure of each image very substantially allows the various particles of adjuvant to be seen very clearly, in particular at low particle flow rates. Under such conditions, the density of the particles in the target zone can be identified accurately and then compared with a threshold value. This guarantees particularly reliable determination of the quantity of adjuvant that is actually present in the stream of molten metal.

The invention is not limited to the example described and shown.

In this respect, FIG. 4 shows a variation that uses an additional camera 14′ in addition to the camera 14 described with reference to the preceding figures. In FIG. 4, which is a plan view, there can be seen the stream of molten metal 6, the supply tube 12, and the flow of particles P of adjuvant.

In this variation, the viewing direction 20 of the first camera 14 extends parallel to the principal axis A of the supply tube 12, which also corresponds to the axis of the flow of adjuvant, when seen from above. In contrast, the viewing direction 20′ of the second camera 14′, while still being directed towards the stream of molten metal 6, is angularly offset relative to the first direction 20 by an angle denoted α. This angle α is typically in the range 10° to 30°, in particular close to 20°.

The arrangement of this FIG. 4 is advantageous in that the second camera 14′ can provide another viewing angle that is offset relative to that provided by the first camera 14. The operator can thus obtain an in-depth view of the whole of the casting operation.

Because of the implementation of FIG. 4, it is possible to detect certain circumstances in which the adjuvant is not poured into the stream but directly into the pouring basin or even to one side thereof, i.e. onto the sand of the mold where it is then completely inoperative.

Under such circumstances, the image produced by the first camera 14 indicates an adjuvant particle density that is not below the threshold value. However, any anomaly will be detected by the second camera 14′ that produces an image from which the particles of adjuvant are absent, which means that the operator will be alerted.

1. A method of checking the flow of a casting adjuvant intended to be distributed when casting a molten metal into a pouring basin (4), wherein the adjuvant is distributed from a supply means (12), in particular tubular supply means, disposed above the pouring basin (4), a target zone (Z) is selected on the theoretical path of said adjuvant disposed downstream from the supply means (12), the actual passage of the adjuvant in the target zone (Z) is detected optically using at least one camera (14, 14′) and if appropriate, an alarm signal is generated;
the method being characterized in that at least one image of the target zone (Z) is produced using the or each camera (14, 14′), applying to said image an exposure that is sufficiently short to identify the density of the particles (P) of said adjuvant present on the or each image, and the alarm signal is generated if the identified particle density is below a predetermined value.

2. A method according to claim 1, characterized in that the exposure for each image is in the range 0.1 ms to 0.5 ms.

3. A method according to claim 2, characterized in that the exposure for each image is about 0.2 ms.

4. A method according to claim 1, characterized in that the adjuvant is distributed at a flow rate of less than 10 g/s, preferably less than 9 g/s.

5. A method according to claim 1, characterized in that the or each camera (14, 14′) is of the CMOS type.

6. A method according to claim 1, characterized in that several images are produced throughout casting of the molten metal into the pouring basin (4) and the alarm signal is generated if, for at least one of said images, the identified particle density of the adjuvant is below said predetermined value.

7. A method according to claim 6, characterized in that two successive images are separated by an interval lasting in the range 40 ms to 80 ms.

8. A method according to claim 1, characterized in that the adjuvant is poured directly into a stream (6) of said molten metal.

9. A method according to claim 1, characterized in that at least one first camera (14) is used, looking along a direction (20) parallel to a principal axis (A) of the flow of adjuvant particles as viewed from above, as well as at least one second camera (14′), looking along a direction (20′) that is angularly offset relative to the direction of the first camera.

10. A method according to claim 1, characterized in that the direction (20) of the first camera (14) and the direction (20′) of the second camera (14′) are mutually offset by an angle in the range 10° to 30°, especially about 20°.
